(19) United States
(12) Patent Application Publication
(10) Pub. No.: US 2024/0151382 A1
(43) Pub. Date: May 9, 2024

(54) VEHICULAR LAMP

(71) Applicant: KOITO MANUFACTURING CO., LTD., Tokyo (JP)

(72) Inventors: Naoya SUGIE, Shizuoka (JP); Kenji YOSHIDA, Shizuoka (JP); Kenta SUZUKI, Shizuoka (JP); Akihiro SUMIYA, Shizuoka (JP)

(21) Appl. No.: 18/549,760

(22) PCT Filed: Mar. 25, 2022
(86) PCT No.: PCT/JP2022/014437

§ 371 Date: Sep. 8, 2023

(30) Foreign Application Priority Data
Apr. 19, 2021 (JP) 2021-070541

(51) Int. Cl. F21S 43/239; F21V 5/04

(52) U.S. Cl. CPC F21S 43/239; F21V 5/04

(57) ABSTRACT

A vehicle lamp is provided which includes an inner lens suitable for diffusion of light. A vehicle lamp is provided which includes: a luminous body configured to emit surface light; and an inner lens placed forward of a light output surface of the luminous body, in which first steps extending in one direction are formed on an input surface of the inner lens, and second steps extending in a direction orthogonal to the first steps are formed on an output surface of the inner lens. It is possible to uniformly diffuse incident light in all directions by orthogonally forming the steps extending in the one directions on the two opposing surfaces, the input and output surfaces, of the inner lens. In addition, mold processing for injection molding is easy. Therefore, the reproducibility is also high.

### TECHNICAL FIELD

The invention of the present application relates to a vehicle lamp including a luminous body that emits surface light and an inner lens placed forward of an output surface of the luminous body, and more particularly to a vehicle lamp capable of diverging light uniformly through the inner lens.

### BACKGROUND ART

The surface of an injection molded product such as an inner lens to be mounted in a vehicle lamp may be subjected to texturing in order to uniformly diffuse incident light (for example, Patent Literature 1).

### CITATION LIST

### Patent Literature

Patent Literature 1: JP-A-2011-110826

### SUMMARY OF INVENTION

### Problems to be Solved by Invention

However, it is difficult to control edging on a mold for texturing. Therefore, there is a problem that the reproducibility of the mold is low. Hence, when inner lenses are produced using different molds, for example, in a case of global production of inner lenses at a plurality of sites, the performance of the inner lenses to be produced varies according to site, and it is difficult to produce the inner lenses with uniform quality.

The present invention has been made in view of this, and provides a vehicle lamp including an inner lens suitable for diffusion of light.

### Solution to Problems

In order to solve the above problem, in one aspect of the present disclosure, a vehicle lamp is configured, including: a luminous body configured to emit surface light; and an inner lens placed forward of a light output surface of the luminous body, in which first steps extending in one direction are formed on an input surface of the inner lens, and second steps extending in a direction orthogonal to the first steps are formed on an output surface of the inner lens.

According to the above aspect, the first and second steps extending in the one directions are diffusing steps, and are formed on the input and output surfaces of the inner lens, that is, two opposing surfaces in such a manner that the first steps are orthogonal to the second steps. Therefore, light incident on the inner lens is diffused uniformly in all directions. In this configuration, edging on a mold of the inner lens is not required, mold processing is relatively easy, the mold has high reproducibility, and an inner lens suitable for diffusion of light alternative to texturing can be provided.

Moreover, in one aspect, it is configured in such a manner that the inner lens is formed to be long in one direction, and the first steps or the second steps are formed, aligning the extending direction thereof with the longitudinal direction of the inner lens. According to this aspect, the flow direction of molten resin and the extending direction of the first or second steps substantially agree with each other at the time of injection molding of the inner lens. Therefore, molding accuracy is increased, and molding defects are also decreased.

Moreover, in one aspect, it is configured in such a manner that a pitch of the first steps and a pitch of the second steps are substantially the same. The divergence of light from the first and second steps is uniform, and the light is diverged uniformly in all directions.

Moreover, in one aspect, it is configured in such a manner that a step radius of the first steps and a step radius of the second steps are 0.4 mm to 1.2 mm. They are in a form in which while molding defects such as burn marks are decreased, the optical characteristics are maintained and light distribution is easily adjusted.

Moreover, in one aspect, it is configured in such a manner that the first steps, the second steps, or the first and second steps together, include a fillet surface formed between adjacent steps. The fillet surface rounds a long and narrow protruding portion or groove portion between the steps. Also on a mold for injection molding, a narrow and deep groove portion and a protruding portion, which form the mold, are eliminated. Therefore, molding defects can be decreased while the optical characteristics are maintained.

Moreover, in one aspect, it is configured in such a manner that a curvature radius of the fillet surface is equal to or greater than 0.30 μm. The fillet surface is designed to have a minimum curvature radius and therefore is in a form in which an influence on the optical characteristics is reduced to a level that can be ignored, and the diffusion characteristics can be maintained.

Moreover, in one aspect, it is configured in such a manner that each of the first steps is a convex step having a height of greater than 0 μm to equal to or less than 23 μm, or a concave step having a depth of greater than 0 μm to equal to or less than 50 μm.

Moreover, in one aspect, it is configured in such a manner that each of the second steps is a convex step having a height of greater than 0 μm to equal to or less than 23 μm, or a concave step having a depth of greater than 0 μm to equal to or less than 50 μm. It is configured in such a manner that it is also possible to achieve compatibility between ease of processing of the mold and maintaining the light diffusion characteristics at a sufficient level.

### Effects of Invention

As is clear from the above description, it is possible to provide a vehicle lamp including an inner lens suitable for diffusion of light.

### BRIEF DESCRIPTION OF DRAWINGS

FIG. 1 is a front view of a vehicle lamp according to an embodiment of the present invention;

FIG. 2 is a horizontal end view of the vehicle lamp taken along line II-II of FIG. 1;

FIG. 3 illustrates a general configuration of an inner lens;

FIG. 4 is a cross-sectional view which is taken along line IV-IV of FIG. 3 and mainly illustrates a cross-sectional form of first steps formed on an input surface side;

FIG. 5 is a cross-sectional view which is taken along line V-V of FIG. 3 and mainly illustrates a cross-sectional form of second steps formed on an output surface side; and

FIG. 6 is modifications.

### DESCRIPTION OF EMBODIMENTS

A specific embodiment of the present invention is described hereinafter with reference to the drawings. The embodiment does not limit the invention and is an exemplification, and all features and combinations thereof, which are described in the embodiment, are not necessarily essential to the invention. Moreover, in the following description of the embodiment and modifications, the same reference signs are assigned to the same configurations, and redundant descriptions are omitted as appropriate. Note that, in the drawings, the features are illustrated in an easy-to-understand manner, and the scales and ratios do not reflect the actual numerical values but schematically represent configurations.

(Vehicle Lamp)

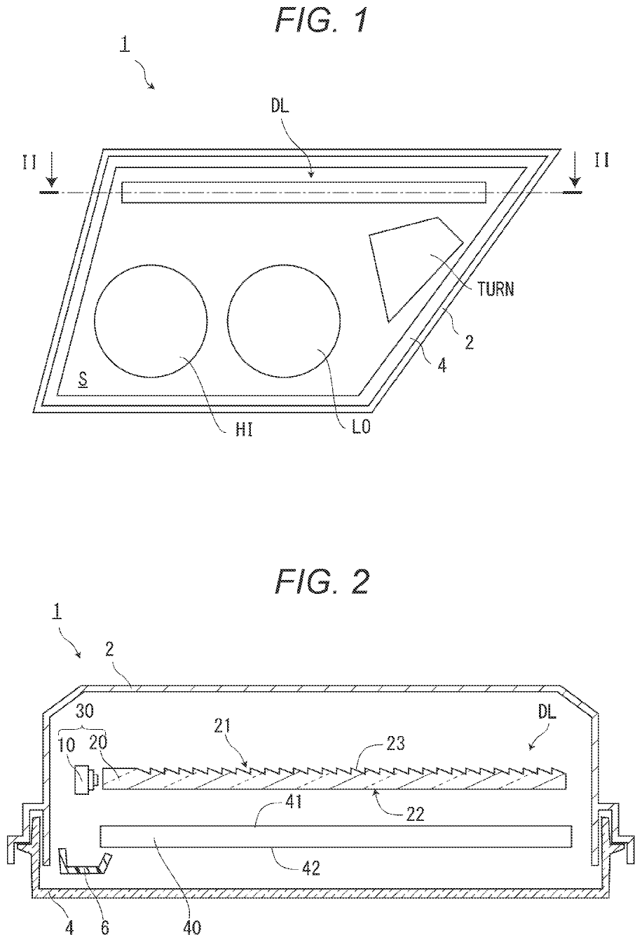

FIG. 1 is a front view of a vehicle lamp 1 according to a preferred embodiment of the present invention. FIG. 2 is an end view taken along line II-II of FIG. 1.

The vehicle lamp 1 is a vehicle headlamp, and is mounted on the right side at the front of a vehicle.

As illustrated in FIG. 1, the vehicle lamp 1 includes a lamp body 2, and a transparent front cover 4 attached to an opening portion of the lamp body 2. The lamp body 2 and the front cover 4 define a light chamber S in the vehicle lamp 1.

The vehicle lamp 1 is a combination lamp that houses a high beam lamp HI, a low beam lamp LO, a turn signal lamp TURN, and a daytime running lamp DL in the light chamber S.

The high beam lamp HI, the low beam lamp LO, and the turn signal lamp TURN are arranged side by side in the vehicle width direction in the light chamber S. For these lamps (HI, LO, and TURN), conventionally well-known configurations such as reflector and projector lamp units are used, and lamps of any type are acceptable.

The daytime running lamp DL is placed along the upper side of the vehicle lamp 1 in the upper area in the light chamber S.

As illustrated in FIG. 2, the daytime running lamp DL includes a light source unit 30 and an inner lens 40. The light source unit 30 includes an LED light source 10 and a light guide 20.

The LED light source 10 is an LED (light Emitting Diode) that emits light when power is supplied thereto. The LED light source 10 is a light source that emits white light diffusely and supplies the light to the light guide 20, and is placed with a light-emitting surface thereof facing the left end surface, which is a light input surface, of the light guide 20.

An extension member 6 placed between the LED light source 10 and the front cover 4 is placed in the light chamber S. The structure of the LED light source 10 is covered with the extension member 6 and concealed from the outside.

The light guide 20 is a rectangular cuboid optical member that is long in one direction, and is formed by injection-molding a transparent resin such as acrylic or polycarbonate. The front side of the light guide 20 along the longitudinal direction thereof is formed as a light guide output surface 22 through which light is emitted. On the back side of the light guide 20, a reflecting surface 21 is formed which includes a plurality of light guide steps 23 that reflect light traveling in the light guide 20, toward the light guide output surface 22. The light guide steps 23 have a triangular prism shape and a cross section thereof along the longitudinal direction has a right triangle shape. The shape of the light guide steps 23 is not limited to the above shape, and may be, for example, a groove or a stipple.

The inner lens 40 is placed forward of the light guide output surface 22 of the light guide 20. The inner lens 40 is a lens for diffusing light uniformly, and the back surface thereof is formed as an input surface 41 and the front surface as an output surface 42. Steps for diffusing light are formed on the input surface 41 and the output surface 42 (the details are described below).

The light source unit 30 is a luminous body having a light-emitting surface that emits surface light. Light that enters from the LED light source 10 travels, repeating total reflection, in the light guide 20. The light incident on the reflecting surface 21 is reflected by the light guide steps 23 toward the light guide output surface 22 and is emitted from the light guide output surface 22.

The light emitted from the light guide output surface 22 is then incident on the input surface 41 of the inner lens 40 placed forward of the light guide output surface 22, diffused, and emitted forward of the vehicle from the output surface 42.

(Inner Lens)

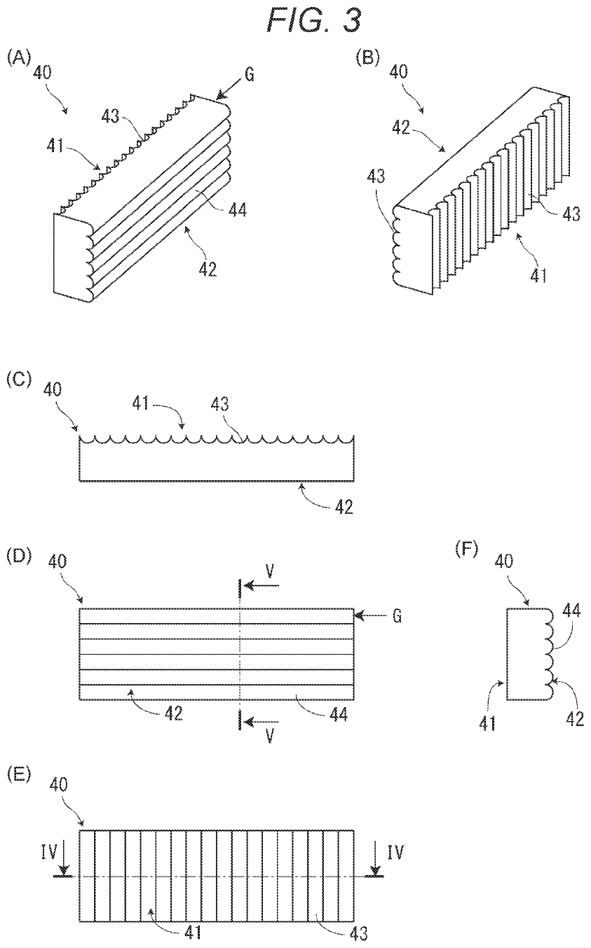

FIG. 3 is general configuration diagrams of the inner lens 40. FIG. 3(A) is a front perspective view mainly illustrating the output surface. FIG. 3(B) is a back perspective view mainly illustrating the input surface. FIG. 3(C) is a plan view, FIG. 3(D) is a front view, FIG. 3(E) is a back view, and FIG. 3(F) is a side view.

As illustrated in FIG. 3, the inner lens 40 has an approximately rectangular cuboid shape that is formed, extending long in one direction (horizontal direction), and is an injection molded product of a resin material having transparency. The inner lens 40 is placed forward of the light guide 20 with the longitudinal direction of the inner lens 40 aligned with the longitudinal direction of the light guide 20. The inner lens 40 is larger than the light guide 20, and is placed in such a manner as to cover the light guide 20 as viewed from the front. The light emitted from the light guide 20 is incident on the inner lens 40.

First steps 43 extending in one direction are formed on the input surface 41 of the inner lens 40. Second steps 44 extending in a direction orthogonal to the first steps 43 are formed on the output surface 42. In the embodiment, the first steps 43 are formed, extending in the vertical direction, and the second steps 44 are formed, extending in the horizontal direction.

(Enlarged Cross-Sectional View)

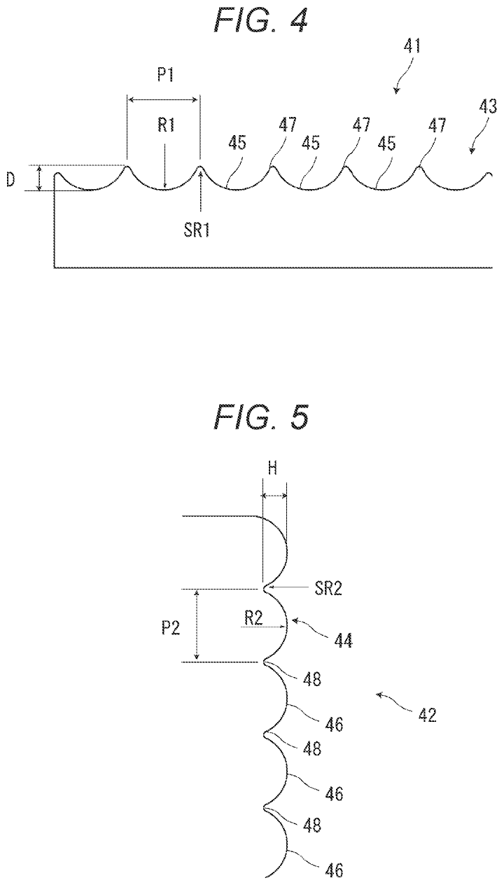

FIG. 4 is an enlarged view of a cross section taken along line Iv-Iv of FIG. 3(E). The cross-sectional shape of the first steps 43 is mainly illustrated. FIG. 5 is an enlarged view of a cross section taken along line v-v of FIG. 3(D). The cross-sectional shape of the second steps 44 is mainly illustrated.

As illustrated in FIGS. 3 and 4, each of the first steps 43 formed on the input surface 41 is formed, extending in the vertical direction being the extending direction while maintaining the same form, and the cross-sectional form (horizontal cross section) orthogonal to the extending direction is substantially the same at any position in the extending direction.

The first steps 43 are concave steps, and countless concave curved surfaces 45 extending in the vertical direction are continuously formed in the horizontal direction with an equal pitch (first pitch P1) on the entire back surface. Furthermore, minimum radius curved surfaces are formed as first fillet surfaces 47 each between adjacent steps. The concave curved surfaces 45 have all the same form, and the first fillet surfaces 47 formed between the concave curved surfaces 45 also have all the same form.

The first fillet surfaces 47 are formed in a convex shape that is an inverted form of the concave first steps 43 in such a manner as to round long and narrow protruding portions formed as boundaries between the adjacent concave steps. Protruding portions of an injection molded product are deep groove portions in a mold for molding. When molten resin reaches the narrow and deep groove portions in the mold during injection molding, the resin may fail to fill the groove portions of the mold. In this case, the holding pressure is applied with trapped air, and what is called burn marks appear. The first fillet surfaces 47 are provided to eliminate the long and narrow groove portions of the mold. Therefore, molding defects such as burn marks are decreased.

Similarly, as illustrated in FIGS. 3 and 5, the second steps 44 formed on the output surface 42 are formed, extending in the horizontal direction being the extending direction while maintaining the same form, and the cross-sectional form (vertical cross section) thereof orthogonal to the extending direction is substantially the same at any position in the extending direction.

The second steps 44 are convex steps, and countless convex curved surfaces 46 extending in the horizontal direction are continuously formed in the vertical direction with an equal pitch (second pitch P2) on the entire front surface. Furthermore, minimum radius curved surfaces are formed as second fillet surfaces 48 each between adjacent steps. The convex curved surfaces 46 have all the same form, and the second fillet surfaces 48 formed between the convex curved surfaces 46 also have all the same form.

The second fillet surfaces 48 are formed in a convex shape that is an inverted form of the convex second steps 44 in such a manner as to round long, narrow, and deep groove portions formed as boundaries between the adjacent convex steps. Groove portions of an injection molded product are long and narrow protruding portions on a mold for molding. When the molten resin reaches the protruding portions on the mold during injection molding, the resin may fail to cover the protruding portions of the mold. In this case, again, the holding pressure is applied with trapped air, and burn marks appear. The second fillet surfaces 48 are provided to round the protruding portions of the mold. Therefore, molding defects such as burn marks are decreased.

In order to achieve compatibility between optical performance and molding performance, a step radius R1 of the first steps 43 (the curvature radius of the concave curved surfaces 45 illustrated in FIG. 4) is preferably 0.4 mm to 1.2 mm. Similarly, a step radius R2 of the second steps 44 (the curvature radius of the convex curved surfaces 46 illustrated in FIG. 5) is preferably 0.4 to 1.2 mm.

Moreover, similarly, a depth D of the first steps, which are concave steps, is preferably greater than 0 μm to equal to or less than 50 μm, more preferably 39 μm to 43 μm. A height H of the second steps 44, which are convex steps, is preferably greater than 0 μm to equal to or less than 23 μm, more preferably 13 μm to 23 μm.

The first pitch P1 and the second pitch P2 are preferably 0.3 mm to 0.7 mm, more preferably 0.4 mm to 0.6 mm to decrease molding defects such as burn marks and perform molding with high accuracy. Moreover, when the first pitch P1 and the second pitch P2 are substantially the same, light can be diffused equally in every direction, which is preferable.

When a curvature radius SR1 of the first fillet surfaces 47 and a curvature radius SR2 of the second fillet surfaces 48 are equal to or greater than 0.30 μm and less than the step radii, molding defects can be decreased, and the mold is easily processed, which is preferable. Furthermore, a curvature radius of 0.32 μm to 0.4 μm is more preferable since an influence on the optical performance is at a level that can be ignored while molding defects are decreased.

### Operations and Effects

The first steps 43 and the second steps 44 are diffusing steps. The two types of diffusing steps that extend in the one directions are formed orthogonal to each other on the input surface 41 and the output surface 42, which face each other. Therefore, the light incident on the inner lens 40 is diffused in the two orthogonal directions and, as a result, is diffused and emitted uniformly in all directions. In other words, as the vehicle lamp 1 is viewed from the front, it is visually recognized that the inner lens 40 emits light uniformly over a wide area due to the input surface 41 and the output surface 42, on which the two types of steps are formed.

Texturing is conventionally used as a means for uniform light diffusion of an inner lens. However, it is difficult to control edging on a mold for texturing. Therefore, there is a problem that the reproducibility of the mold is low. When injection molding is performed with different molds due to, for example, global production, it is difficult to impart the equivalent optical characteristics and quality to resin molded products. On the other hand, the use of the configuration of the present disclosure offers advantages in the elimination of the need for edging on a mold, relatively easy processing of the mold, and high reproducibility of the mold. The steps that form a lattice shape in front view are provided as the steps extending in the one directions on the two opposing surfaces. Therefore, mold processing is facilitated, and the mold processing cost can be kept low. Moreover, the processing of the mold is easier than edging and easy to control. Therefore, the degree of flexibility in adjusting light distribution is also high. An inner lens suitable for uniform light diffusion can be provided.

(Modifications)

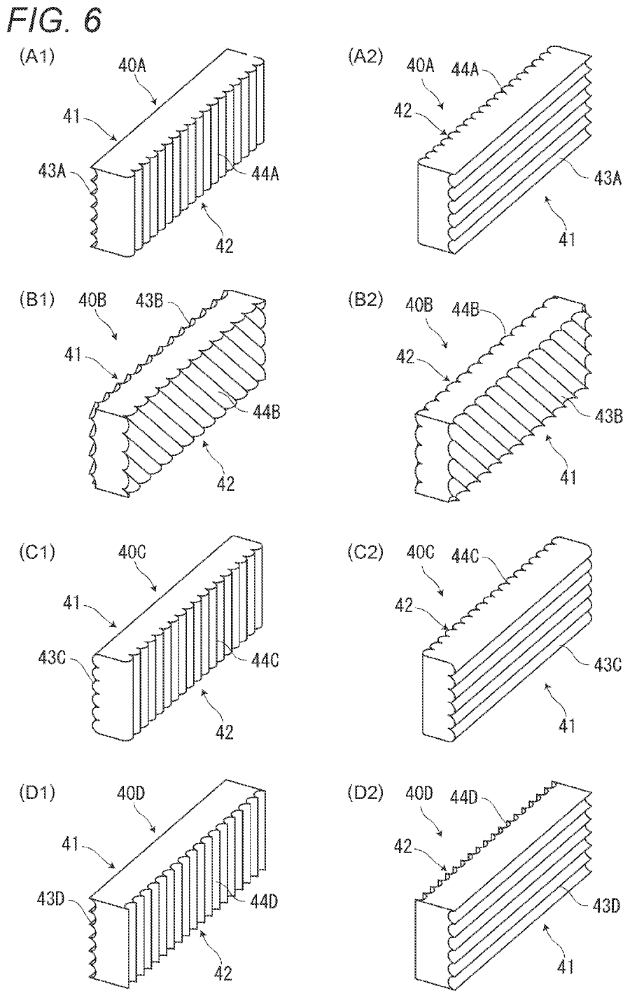

In order to restrain non-uniform diffusion of light (imbalanced light, what is called moire, as viewed from the front), the extending direction of the first steps 43 formed on the input surface 41 and the extending direction of the second steps 44 formed on the output surface 42 need to be orthogonal to each other. However, the form is not limited to that of the embodiment. Other forms are described as modifications with reference to FIG. 6. Inner lenses 40A, 40B, 40C, and 40D illustrated in FIG. 6 are modifications. FIGS. 6(A1), 6(B1), 6(C1), and 6(D1) are front perspective views, and mainly illustrate the output surface side. FIGS. 6(A2), 6(B2), 6(C2), and 6(D2) are back perspective views, and mainly illustrate the input surface side.

For example, on the inner lens 40A illustrated in FIGS. 6(A1) and 6(A2), first steps 43A are formed, extending in the horizontal direction, and second steps 44A are formed, extending in the vertical direction. On the inner lens 40B illustrated in FIGS. 6(B1) and 6(B2), first steps 43B are formed, inclined at a predetermined angle with respect to the horizontal direction, and second steps 44B are formed, extending in a direction orthogonal to the first steps 43B. As described above, the extending directions of the steps are not limited to the up-and-down or left-and-right direction, and the steps can be formed in accordance with the shape of the inner lens.

The same applies to the concave and convex forms of the steps formed on the surfaces. On the inner lens 40C illustrated in FIGS. 6(C1) and 6(C2), first steps 43C are convex steps, and second steps 44C are also convex steps. On the inner lens 40D illustrated in FIGS. 6(D1) and 6(D2), first steps 43D are concave steps, and second steps 44D are also concave steps. As described above, the convex steps and the concave steps can be freely combined.

It is simply required to form the second steps 44, extending in the direction orthogonal to the extending direction of the first steps 43. Consequently, the incident light is diffused in the two orthogonal directions, and the inner lens 40 can diverge the light uniformly. It is preferable that the second steps 44 formed on the output surface 42 be formed, aligning the extending direction thereof with the longitudinal direction of the inner lens 40. This is described, retuning to FIG. 3.

As illustrated in FIGS. 3(A) and 3(D), the inner lens 40 is formed to be long in one direction, and has a gate mark G for injection molding at an end in the longitudinal direction. Hence, when the inner lens 40 is molded, the molten resin is injected along the longitudinal direction of the inner lens 40. As described above, generally, when a product having a shape that is long in one direction is injection-molded, the gate is provided on a side surface in the longitudinal direction, and the molten resin is injected along the longitudinal direction. Consequently, wraparound is avoided, the molten resin easily reaches an end, and molding defects are decreased. Similarly, when the extending direction of the steps that extend in one direction is formed along the injection direction of the molten resin, defects such as burn marks, which result from molding with trapped air on the uneven surface of the mold, are decreased, and the molding accuracy is increased, which is preferable. In the embodiment, the second steps 44 are formed along the longitudinal direction of the inner lens 40. Consequently, the second steps 44 are formed substantially along the flow direction of the molten resin. Therefore, it is possible to decrease molding defects and increase the molding accuracy.

The gate location is determined based on, for example, the entire shape of an injection molded product and the form of a mold. It is preferable to align the extending direction of either the first steps 43 or the second steps 44 with the sliding direction of the molten resin, whereby molding defects are decreased. It is more preferable to align the step extending direction of the second steps 44 with the extending direction of the molten resin. The second steps 44 formed on the output surface 42 are visually recognized from the front of the vehicle lamp 1. Therefore, the appearance of the inner lens 40 is also improved by increasing the molding accuracy of the second steps 44.

Up to this point the preferred embodiments and modifications of the present invention have been described. However, the above embodiments are examples of the present invention, and can be combined based on knowledge of those skilled in the art. Such a form is also included in the scope of the present invention.

The present international application claims priority based on Japanese Patent Application No. 2021-070541, which is a Japanese patent application filed on Apr. 19, 2021, the entire contents of which are incorporated herein by reference.

The above description of the specific embodiment of the present invention has been presented for the purpose of illustration. The description is not intended to be exhaustive or to limit the present invention as it is in the described form. It is obvious to those skilled in the art that many modifications and alternations can be made in light of the above description.

### LIST OF REFERENCE SIGNS

1 Vehicle lamp
10 LED light source
20 Light guide
22 Light guide output surface
30 Light source unit
40 Inner lens
41 Input surface
42 Output surface
43 First step
44 Second step
47 First fillet surface
48 Second fillet surface
D Depth
H Height
P1 First pitch
P2 Second pitch
R1 Step radius (of the first step)
R2 Step radius (of the second step)
SR1 Curvature radius (of the first fillet surface)
SR2 Curvature radius (of the second fillet surface)

1. A vehicle lamp comprising:
a luminous body configured to emit surface light; and
an inner lens placed forward of a light output surface of the luminous body,
wherein first steps extending in one direction are formed on an input surface of the inner lens, and second steps extending in a direction orthogonal to the first steps are formed on an output surface of the inner lens.

2. The vehicle lamp according to claim 1, wherein
the inner lens is formed to be long in one direction, and
the first steps or the second steps are formed, aligning the extending direction thereof with the longitudinal direction of the inner lens.

3. The vehicle lamp according to claim 1, wherein
a pitch of the first steps and a pitch of the second steps are substantially the same.

4. The vehicle lamp according to claim 1, wherein
a step radius of the first steps and a step radius of the second steps are 0.4 mm to 1.2 mm.

5. The vehicle lamp according to claim 1, wherein
the first steps, the second steps, or the first and second steps together, include a fillet surface formed between adjacent steps.

6. The vehicle lamp according to claim 5, wherein
a curvature radius of the fillet surface is equal to or greater than 0.30 μm.

7. The vehicle lamp according to claim 1, wherein
each of the first steps is a convex step having a height of greater than 0 μm to equal to or less than 23 μm, or a concave step having a depth of greater than 0 μm to equal to or less than 50 μm.

8. The vehicle lamp according to claim 1, wherein
each of the second steps is a convex step having a height of greater than 0 μm to equal to or less than 23 μm, or a concave step having a depth of greater than 0 μm to equal to or less than 50 μm.
